(19) United States
(12) Patent Application Publication
(10) Pub. No.: US 2017/0225415 A1
(43) Pub. Date: Aug. 10, 2017

(54) METHOD OF REPAIRING A TIRE AND TIRE INFLATION SYSTEM

(71) Applicant: Dana Heavy Vehicle Systems Group, LLC, Maumee, OH (US)

(72) Inventor: Douglas D. Turner, Holland, OH (US)

(21) Appl. No.: 15/419,724

(22) Filed: Jan. 30, 2017

Related U.S. Application Data
(60) Provisional application No. 62/291,974, filed on Feb. 5, 2016.

(51) Int. Cl. B29C 73/20; B60C 23/00; B60C 23/04

(52) U.S. Cl. CPC B29C 73/20; B60C 23/0408; B60C 23/003

(57) ABSTRACT

A method of repairing a tire includes providing a tire. The tire has a tire pressure. It is determined if the tire pressure is below a target tire pressure. If the tire pressure is below the target tire pressure a first flow of pressurized air is directed to the tire. It is determined if the tire is torn or punctured. If it is determined that the tire is torn or punctured, a signal is sent to a heating element to produce heat energy. The heat energy is transferred to a second flow of pressurized air. The heated, second flow of pressurized air is directed to the tire.

### CROSS-REFERENCE TO RELATED APPLICATION

This application is claiming the benefit, under 35 U.S.C. 119(e), of the provisional U.S. patent application which was granted Ser. No. 62/291,974 and filed on Feb. 5, 2016, the entire disclosure of which is hereby incorporated by reference.

### BACKGROUND OF THE INVENTION

The invention relates to a tire inflation system. The invention also relates to a method of repairing a tire.

It is known to employ one or more tires on a vehicle. It has recently been discovered that tires can be formed from materials which allow the tire to heal after being cut or punctured. Such so called “self-healing” can occur under normal atmospheric conditions.

It would be advantageous to provide a tire inflation system that can accelerate the healing of a tire made from such materials. A method of repairing a tire made from such materials would also be advantageous.

### BRIEF SUMMARY OF THE INVENTION

Embodiments of a method of repairing a tire are provided.

In an embodiment, the method comprises providing a tire. The tire has a tire pressure. It is determined if the tire pressure is below a target tire pressure. If the tire pressure is below the target tire pressure a first flow of pressurized air is directed to the tire. It is determined if the tire is torn or punctured. If it is determined that the tire is torn or punctured, a signal is sent to a heating element to produce heat energy. The heat energy is transferred to a second flow of pressurized air. The heated, second flow of pressurized air is directed to the tire.

In another embodiment, the method comprises providing a tire. The tire has a tire pressure. It is determined if the tire pressure is below a target tire pressure. If the tire pressure is below the target tire pressure a first flow of pressurized air is directed to the tire. It is determined if the tire is torn or punctured. If it is determined that the tire is torn or punctured, a first signal is sent to a heating element to determine an operating condition of the heating element and a second signal is sent to the heating element to produce heat energy. The heat energy is transferred to a second flow of pressurized air. The heated, second flow of pressurized air is directed to the tire.

### BRIEF DESCRIPTION OF THE SEVERAL VIEWS OF THE DRAWING

The above, as well as other advantages of the process will become readily apparent to those skilled in the art from the following detailed description when considered in the light of the accompanying drawings in which:

FIG. 1 depicts a schematic view of a tire inflation system in accordance with the invention; and

FIG. 2 depicts a schematic view of a flow chart for a method configured in accordance with the invention.

### DETAILED DESCRIPTION OF THE INVENTION

It is to be understood that the invention may assume various alternative orientations and step sequences, except where expressly specified to the contrary. It is also to be understood that the specific assemblies, systems and methods illustrated in the attached drawings, and described in the following specification are simply exemplary embodiments of the inventive concepts. Hence, specific dimensions, directions or other physical characteristics relating to the embodiments disclosed are not to be considered as limiting, unless expressly stated otherwise. Also, although they may not be, like elements in various embodiments may be commonly referred to with like reference numerals within this section of the application.

Embodiments of a tire inflation system and a method of repairing a tire are described herein. The embodiments of the tire inflation system and the method may have applications to commercial and off-highway vehicles (not depicted). Also, it would be understood by one of ordinary skill in the art that these embodiments could have industrial, locomotive, military and aerospace applications.

The tire inflation system may be of the central tire inflation system (CTIS) variety. Also, the tire inflation system may have inflate only capability to allow one or more tire pressures to be increased. Alternatively, the tire inflation system may have inflate and deflate capability to allow one or more tire pressures to be increased and/or decreased. Additionally, the tire inflation system may have additional functionality not specifically discussed herein and perform other processes known to those skilled in art.

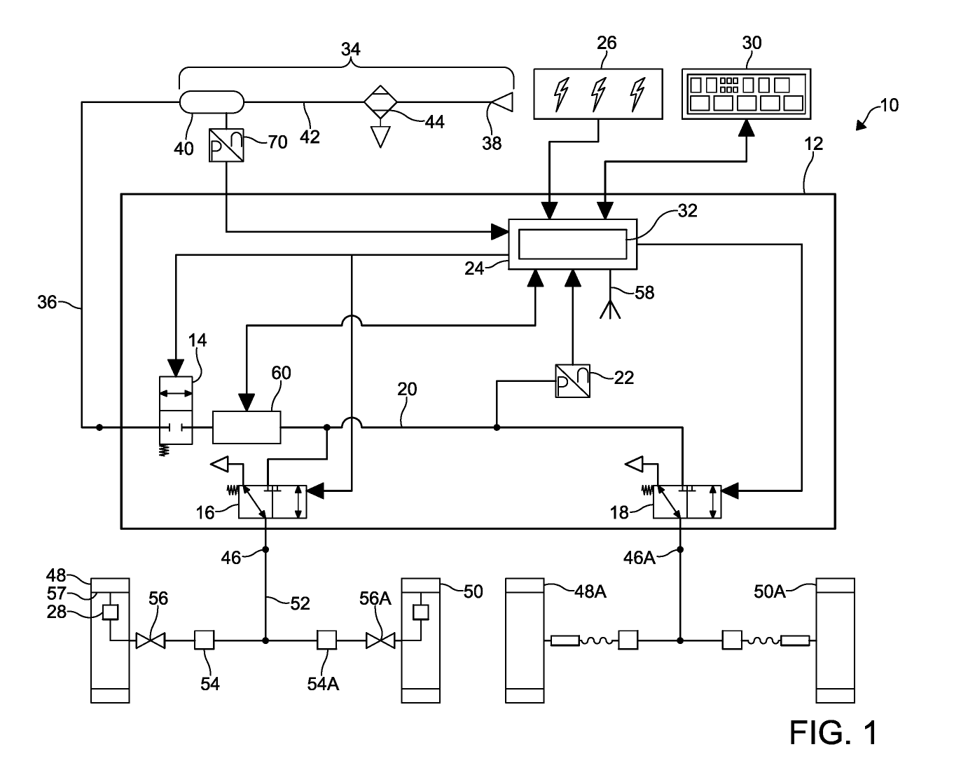

With reference to FIG. 1, the tire inflation system 10 comprises a pneumatic control unit (PCU) 12. The PCU 12 comprises a plurality of valve assemblies 14, 16, 18, which may be of the solenoid variety, and a first fluid conduit 20 for controlling the flow of and directing pressurized air through the PCU 12. The PCU 12 may also comprise a PCU pressure sensor 22. The PCU pressure sensor 22 is provided in fluid communication with the first fluid conduit 20.

Preferably, the PCU 12 also comprises a microcontroller 24. The microcontroller 24 receives input signals from the PCU pressure sensor 22. The microcontroller 24 may also receive input from one or more additional sensors such as, for example, a temperature sensor 28. Additionally, the microcontroller 24 may receive input signals from a power supply 26 and an operator control device 30. In certain embodiments, the power supply 26 is a battery of the vehicle.

The microcontroller 24 operates under the control of a set of programming instructions, which may also be referred to as software. The set of programming instructions may be organized to provide a master tire pressure maintenance program. Preferably, the master tire pressure maintenance program is configured to allow the PCU 12 to facilitate checking the tire pressure and, if needed, increasing and/or decreasing the tire pressure. The microcontroller 24 may include a memory 32 in which programming instructions are stored. The memory can 32 also store identification codes, tire pressure records and/or user inputs over a period of time.

The microcontroller 24 outputs signals to the valve assemblies 14-18 to open or close the valve assemblies 14-18. The microcontroller 24 may also output signals to a display device (not depicted). The display device may be included as a part of the operator control device 30 or a freestanding device.

The PCU 12 selectively communicates with an air supply 34 via an air supply circuit 36. When the PCU 12 and the air supply 34 are in fluid communication, the tire pressure may be checked and, if needed, increased and/or decreased. The PCU pressure sensor 22 measures the pressure of the air supply 34 via the air supply circuit 36 and the first fluid conduit 20. The PCU pressure sensor 22 may also be utilized to measure the tire pressure.

The air supply 34 is preferably provided by an air compressor 38 attached to the vehicle. Preferably, the air supply 34 also comprises a reservoir 40 such as, for example, a wet tank. The compressor 38 is in fluid communication with the reservoir 40 via a supply conduit 42. The air compressor 38 supplies pressurized air to the reservoir 40 for storage therein. A reservoir pressure sensor 70 may also be provided. When provided, the reservoir pressure sensor 70 sends input signals to the microcontroller 24 that indicate the pressure of the air in the reservoir 40. Pressurized air from the air supply 34 is provided to the air supply circuit 36 via the reservoir 40. In certain embodiments, a drier 44 is provided for removing water from the air supply 34. A filter (not depicted) may also be interposed in the air supply circuit 36 or the supply conduit 42.

The PCU 12 is selectively in fluid communication with one or more fluid control circuits 46, 46A. Each fluid control circuit 46, 46A is utilized to provide fluid communication between the PCU 12 and one or more tires 48, 48A, 50, 50A. Preferably, fluid communication between the PCU and fluid control circuit 46, 46A is controlled by opening or closing a channel valve assembly 16, 18.

Preferably, each fluid control circuit 46, 46A is similarly configured. Thus, for the purpose of describing the tire inflation system 10, only one fluid control circuit 46 will be described below. The fluid control circuit 46 may comprise one or more fluid conduits 52 and one or more rotary assemblies 54, 54A. In certain embodiments, one or more of the rotary assemblies 54, 54A includes one or more air seals.

One or more wheel valves 56, 56A may be provided as a portion of the fluid control circuit 46. Preferably, each wheel valve 56, 56A is similarly configured. Thus, for the purpose of describing the tire inflation system 10, only one wheel valve 56 will be described below. The wheel valve 56 is utilized to allow the tire inflation system 10 to selectively communicate pressurized air to a tire 48. The wheel valve 56 is moveable from a closed position to an open position and vice versa to permit or prevent fluid communication of pressurized air from the tire inflation system 10 to the tire 48. When pressurized air is being directed to the tire 48, the wheel valve 56 is in an open position.

The tire 48 houses pressurized air at a certain pressure. The pressurized air housed in the tire 48 may be referred to herein as tire pressure. The tire inflation system 10 and method will be described below with reference to one tire 48. However, it should be appreciated that each tire 48, 48A, 50, 50A can be similarly configured. Thus, the tire inflation system 10 and method described herein can be utilized with one or more tires 48, 48A, 50, 50A.

Preferably, the tire 48 comprises a material having self-healing properties. It should be appreciated that the term “self-healing,” refers to the material's ability to eliminate a puncture or tear in the material over time. Preferably, the puncture or tear is eliminated over a predetermined period of time. In an embodiment, the tire may be formed in whole or in part with the material. In another embodiment, the material may be provided in a coating or a layer disposed within the tire or over one or more surfaces of the tire. Thus, as the material is provided as a portion of the tire 48, the puncture or tear is eliminated from the tire 48.

Preferably, the material is an elastomer. In this embodiment, the elastomer may be of the rubber variety. In one such embodiment, the tire 48 comprises butyl rubber. More preferably, the tire 48 comprises bromobutyl rubber. Preferably, the rubber material has been ionically modified. In one such embodiment, the rubber material comprises an ionic network. Preferably, the ionic network comprises ionic groups. It is preferred that the ionic groups comprise reversible ionic associates. Preferably, the ionic associates have physical cross-linking ability. In one such embodiment, the ionic groups include one or more ionic imidazolium bromide groups. In this embodiment, the material may comprise ionically cross-linked bromobutyl rubber. An example of a rubber material having self-healing properties and suitable for use in forming the tire 48 and in practicing the method is described in the article authored by Das et al. and entitled “Ionic Modification Turns Commercial Rubber into a Self-Healing Material.” Preferably, the material has self-healing properties which increase when exposed to added heat energy.

The temperature sensor 28 is in fluid communication with fluid control circuit 46. Preferably, the temperature sensor 28 is provided near the interface between the fluid control circuit 46 and the tire 48. In these embodiments, the temperature sensor 28 may be housed within the tire 48 or a wheel rim 57. Alternatively, separate encapsulation (not depicted) may be provided to house the temperature sensor 28.

Temperature sensors known in the art are suitable for use in the tire inflation system 10. The temperature sensor 28 measures the temperature of the pressurized air being directed to the tire 48. After measuring the temperature, the temperature sensor 28 provides a signal to the microcontroller 24 corresponding to the temperature of the pressurized air in the fluid control circuit 46. Since the temperature sensor 28 is provided near the interface between the fluid control circuit 46 and the tire 48, the temperature sensor 28 measures the temperature of the pressurized air flowing into the tire 48. Thus, the signal provided to the microcontroller 24, is indicative of the temperature of the pressurized air flowing into the tire 48. When air is not flowing into tire 48 via the fluid control circuit 46, the temperature sensor 28 provides a signal to the microcontroller that indicates the current temperature of the pressurized air in tire 48.

Preferably, the temperature sensor 28 is of the wireless variety. When the temperature sensor 28 is of the wireless variety, the signal provided by the temperature sensor 28 is transmitted to the microcontroller 24 without a wire connecting the temperature sensor 28 and the microcontroller 24. The signal transmitted to the microcontroller 24 may be in the form of one or more radio waves. In this embodiment, the temperature sensor 28 may be in communication with a radio transmitter.

Preferably, a power source is provided near the temperature sensor 28 to provide power to the temperature sensor 28. Preferably, the power source is provided adjacent the temperature sensor 28. In certain embodiments, the power source stores energy which can then be provided to the temperature sensor 28 when it is required. In an embodiment, the power source is a battery. In another embodiment, the power source is a capacitor. The battery or capacitor stores energy that is utilized by the temperature sensor 28. The energy provided by the power source to the temperature sensor 28 can also be utilized to provide the signal from the sensor to the microcontroller 24.

In embodiments where the temperature sensor 28 is of the wireless variety and one or more of the signals provided by the temperature sensor 28 are in the form of one or more radio waves, the microcontroller 24 comprises a receiver 58 capable of receiving radio frequency transmissions. The radio frequency transmissions may be decoded and utilized to adjust the temperature of the pressurized air being directed to the tire 48 and/or sent to the operator control device 30 or another device to display information related to the status of the tire 48.

The temperature of the pressurized air being directed to the tire 48 is adjusted by providing a heating element 60. The heating element 60 converts electrical energy provided to it into heat energy. The heat energy produced by the heating element 60 is then transferred to the pressurized air as the air is directed through the first fluid conduit 20 to increase the temperature of the pressurized air. From the first fluid conduit 20, the heated pressurized air is directed to the tire 48 via the fluid control circuit 46.

As illustrated in FIG. 1, the heating element 60 may be provided as a portion of the PCU 12. In this embodiment, the heating element 60 can be provided so that a portion thereof is disposed within the first fluid conduit 20. Alternatively, the heating element 60 can be provided around a portion of the first fluid conduit 20. In this embodiment, the heating element 60 may be a heat tape. In other embodiments (not depicted), the heating element may be provided in another portion of the tire inflation system 10. For example, in an embodiment, the heating element 60 may be disposed in the reservoir 40. In other embodiments (not depicted), one or more heating elements may be provided as a portion of the tire inflation system 10 but be positioned outside the PCU 12. In one such embodiment, separate heating elements are provided and each heating element communicates with a separate fluid control circuit 46, 46A.

The microcontroller 24 communicates with the heating element 60. When it is desired to provided heated pressurized air to the tire 48, the microcontroller 24 outputs one or more signals to the heating element 60 and may receive one or more signals from the heating element 60. In an embodiment, a first signal provided to the heating element 60 from the microcontroller 24 is utilized to determine the status of the element. The heating element 60 may then send a signal back to the microcontroller 24 which indicates whether the element is operating normally.

If the heating element 60 is operating normally and the signal provided to microcontroller 24 indicates the same, the microcontroller 24 provides another signal to the heating element 60 to begin producing heat energy. If the signal from the heating element 60 to the microcontroller 24 indicates that the element is not operating normally or if no signal is received from the heating element 60, a trouble code is recorded. Preferably, the trouble code is recorded by the microcontroller 24. When a trouble code is recorded, the microcontroller 24 may send a signal to the operator control device 30 indicating a recorded trouble code. If such a signal is received by the operator control device 30, then the operator control device 30 may alert an operator that a trouble code has been recorded and that the trouble code relates to the heating element 60 and/or the status of the tire inflation system 10.

It should also be appreciated that when it is desired to provide heated pressurized air to the tire 48, the microcontroller also outputs signals to the supply valve assembly 14 and the appropriate channel valve assembly 16 to open the valve assemblies 14, 16. Furthermore, when it is desired to provide heated pressurized air to the tire 48, the wheel valve 56 is open. Opening the supply valve assembly 14 allows pressurized air to be directed into the PCU 12. In the PCU 12, the pressurized air can be heated by the heating element 60. Opening the channel valve assembly 16 and the wheel valve 56, allows the heated pressurized air in the PCU to be directed to the tire 48 via the fluid control circuit 46 as discussed above.

It has been discovered that if the tire 48 is formed from the self-healing rubber materials described above and if the tire 48 is torn or punctured, the tire 48 will repair itself at an accelerated rate when heated. Advantageously, the tire 48 can be heated by heating pressurized air and directing the heated pressurized air into the tire 48 as described above. Preferably, the heated pressurized air is directed into the tire 48 within a time period defined by the tire manufacturer of the tire 48 once it has been torn or punctured. Preferably, the temperature of the heated pressurized air is at a predetermined temperature specified by the tire manufacturer to maximize the acceleration of self-healing of the tear or puncture. By providing heated pressurized air as described above, a tire which has been punctured or torn can repair itself by eliminating the tear or puncture.

As such, a method of repairing a tire is also provided. The method will be described below with reference to repairing one tire 48. However, it should be noted that the method can be utilized to repair two or more tires 48, 48A, 50, 50A simultaneously. It should also be noted that the method of repair can be practiced when the vehicle is stationary or when the vehicle is being driven.

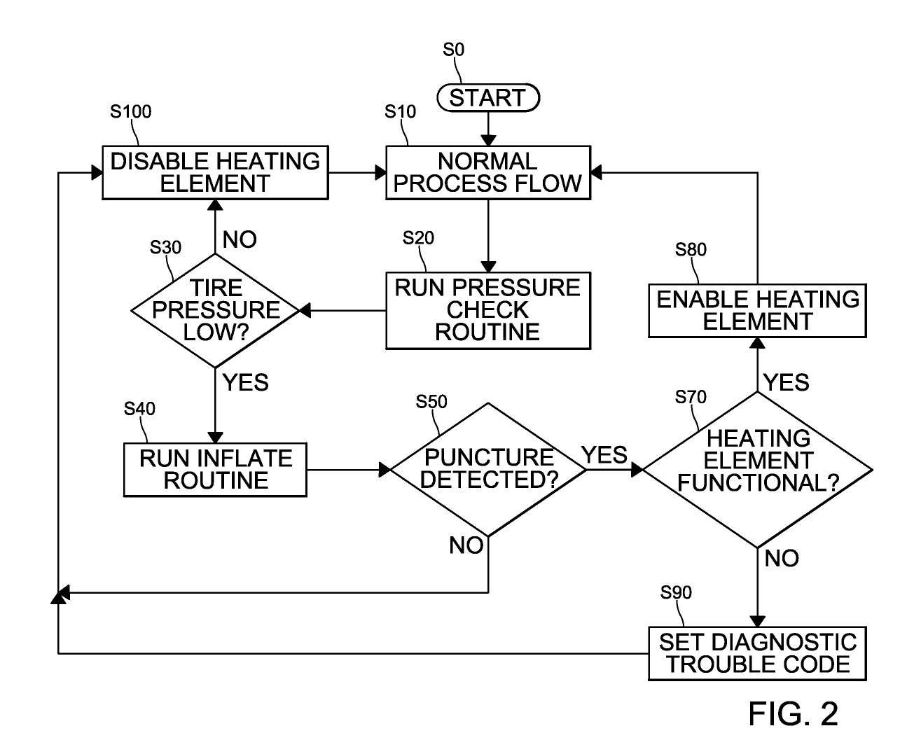

Referring now to FIGS. 1-2, the method is practiced utilizing a tire inflation system 10. The tire inflation system 10 may be as described above and as illustrated in FIG. 1. It should be appreciated that the method may still be practiced with other embodiments of tire inflation systems.

At step SO and step S10, the tire inflation system 10 may be operating according to the master tire pressure maintenance program. The method described herein may be a routine called during execution of the master tire pressure maintenance program. From step S10, at the appropriate instance, the method proceeds to step S20.

At step S20, the tire inflation system 10 measures a tire pressure for the tire 48. From step S20, the method proceeds to step S30. At step S30, it is determined if the tire pressure is below a target tire pressure. If it is determined that the tire pressure is equal to or greater than the target tire pressure, then from step S30 the method proceeds to step S100. At step S100, the heating element 60 is disabled. Once the heating element 60 is disabled at step S100, the method proceeds back to step S10 where the tire inflation system 10 may continue to operate according to the master tire pressure maintenance program, and at the appropriate instance, repeat the method by proceeding to step S20.

If at step S30 it is determined that the tire pressure is below the target tire pressure, then the method proceeds to step S40. At step S40, increasing the tire pressure to the target tire pressure is attempted. To increase the tire pressure to the target tire pressure, pressurized air is directed to the tire 48. To direct pressurized air to the tire 48, the microcontroller 24 outputs signals to the supply valve assembly 14 and the channel valve assembly 16 to open the valve assemblies 14, 16. Furthermore, when it is desired to provide pressurized air to the tire 48, the wheel valve 56 is open. Opening the supply valve assembly 14 allows pressurized air to be directed into the PCU 12. From the PCU 12, the pressurized air is directed through the valve assemblies 14, 16, 56 and fluid control circuit 46 to the tire 48. Pressurized air may be directed to the tire 48 for a predetermined period of time to increase the tire pressure to the target tire pressure.

After it is attempted to increase the tire pressure to the target tire pressure at step S40, the method proceeds to step S50. At step S50, it is determined if the tire 48 is torn or punctured. To determine if the tire 48 is torn or punctured, the tire pressure may be measured. In an embodiment, the tire pressure is dynamically measured as pressurized air is directed to the tire to increase the tire pressure to the target tire pressure. After a predetermined time, if the tire pressure is not equal to the target tire pressure, then it may be determined that the tire 48 is torn or punctured. However, it should be appreciated that a tear or puncture can be determined utilizing another method or in another manner.

When it is determined that the tire 48 is not punctured or torn, the method proceeds from step S50 to step S100. Those skilled in the art should appreciate that the method is a loop in the overall master tire pressure maintenance program. As such, in a prior instance of the execution, S50 may had determined that a puncture or tear did exist, however, in the current instance, the self-healing properties of the tire have completed the healing process and the puncture or tear no longer exist. At step S100, the heating element 60 is disabled. Once the heating element 60 is disabled at step S100, the method proceeds back to step S10 where the tire inflation system 10 may continue to operate according to the master tire pressure maintenance program, and at the appropriate instance, repeat the method by proceeding to step S20. However, when it is determined that the tire 48 is torn or punctured, the method proceeds from step S50 to step S70. At step S70, it is determined if the heating element 60 is operating normally. The operating condition of the heating element 60 is determined when the microcontroller 24 sends the first signal to the heating element 60 as described above. If it is determined that the heating element 60 is operating normally, then the method proceeds to step S80.

At step S80, the microcontroller 24 provides another signal to the heating element 60 to produce heat energy. The heating element 60 can produce heat energy for a predetermined period of time or for as long as the microcontroller 24 sends a signal thereto to produce heat energy. In one embodiment, the microcontroller 24 may use the data provided by the temperature sensor 28 to control the heating element 60 to ensure the desired temperature is being provided as specified by the tire manufacturer to maximize the acceleration of self-healing of the tear or puncture. In certain embodiments, heat energy is provided by the heating element 60 until the tire 48 is repaired by eliminating the tear or puncture or until a desired rate of repair is achieved.

In embodiments where the vehicle is stationary and it has been determined that the tire 48 is torn or punctured at step S50 and that the heating element 60 is operating normally at step S70, the signal to the heating element 60 to produce heat energy may be provided by the microcontroller 24 for a predetermined time. Limiting the signal provided by the microcontroller 24 to a predetermined time reduces the likelihood that the vehicle battery providing power to the microcontroller 24 will be drained to an unacceptably low level. It should be appreciated that if the vehicle battery is drained to a low level, then other critical users of such the power may not receive enough power to operate properly. In embodiments, the microcontroller 24 monitors the state of life for power supply 26 to determine energy consumption limitation of the tire inflation system 10. Furthermore, in embodiments, the method may also comprise directing the pressurized air into the tire 48 for a predetermined time. Limiting the pressurized air direct to the tire 48 to a predetermined time reduces the likelihood that the pressurized air in the reservoir 40 will be drained to an unacceptably low level. It should be appreciated that if the pressurized air in the reservoir 40 is drained to a low level, then other critical users of the pressurized air stored in reservoir 40 such as, for example, the vehicle's braking system may not receive enough pressurized air to operate properly. In other embodiments, pressurized air directed to the tire 48 may be provided until the microcontroller 24 receives an input signal from the reservoir pressure sensor 70 indicating that the pressure of the air in the reservoir 40 is below a threshold level. Once such a signal from the reservoir pressure sensor 70 is received by the microcontroller 24, the microcontroller 24 can output a signal to the supply valve assembly 14 to close the valve assembly 14 to prevent additional pressurized air from being removed from the reservoir 40 to repair the tire 48. In another embodiment, the microcontroller 24 may execute an algorithm which maximizes the acceleration and probability of repairing the self-healing tire by leveraging the data provided by the temperature sensor 28 and the pressure sensor 70 along with the current state of the power supply 26 of the tire inflation system 10. The microcontroller 24 may also determine the balance between energy usage and air pressure consumption to maximize the acceleration and probability of success in repairing a tear or puncture.

In certain embodiments, the rate at which the puncture or tear is repaired can be controlled by controlling the temperature of the pressurized air being directed into the tire 48. For example, as discussed above, the temperature sensor 28 measures the temperature of the pressurized air being directed to the tire 48 and provides a signal to the microcontroller 24 corresponding to the temperature of the pressurized air in the fluid control circuit 46. Thus, if the signal provided by the temperature sensor 28 indicates that the temperature of the pressurized air in the fluid control circuit 46 is too low to repair the tire in a desired period of time, the temperature of the pressurized air in the fluid control circuit 46 can be increased utilizing additional heat energy provided by the heating element 60. Alternatively, if the signal provided by the temperature sensor 28 indicates that the temperature of the pressurized air in the fluid control circuit 46 is too high to repair the tire in a desired period of time or that the tire is being excessively heated, the temperature of the pressurized air in the fluid control circuit 46 can be decreased by removing the signal provided to the heating element 60 by the microcontroller 24.

As the amount of time to repair a punctured or torn tire is directly related to the physical properties of puncture or tear, the method described herein is executed as part of the repetitive loop of the master tire pressure maintenance program. Steps S10 through S100 are repeated per the requirements of the master tire pressure maintenance program. Different branches of the method are taken depending on the current state of step S30, step S50, and step S70.

If it is determined that the heating element 60 is not operating normally, then the method proceeds from step S70 to step S90. At step S90, a trouble code is recorded related to the heating element 60 not operating normally. Also, if it is determined that the heating element 60 is not operating normally, then the microcontroller 24 does not send another signal to the heating element 60.

From step S90 the method proceeds to step S100. At step S100, the heating element 60 is disabled. Once the heating element 60 is disabled at step S100, the method proceeds back to step S10 where the tire inflation system 10 may continue to operate according to the master tire pressure maintenance program, and at the appropriate instance, repeat the method by proceeding to step S20.

The method can be repeated as needed to repair the tire 48 or another tire 48A, 50, 50A if additional punctures or tears occur or to determine whether the tire 48 or another tire 48A, 50, 50A has been torn or punctured.

In accordance with the provisions of the patent statutes, the present invention has been described in what is considered to represent its preferred embodiments. However, it should be noted that the invention can be practiced otherwise than as specifically illustrated and described without departing from its spirit or scope.

1. A method of repairing a tire, comprising:
providing a tire, the tire having a tire pressure;
determining if the tire pressure is below a target tire pressure and if the tire pressure is below the target tire pressure directing a first flow of pressurized air to the tire;
determining if the tire is torn or punctured and, if it is determined that the tire is torn or punctured, sending a signal to a heating element to produce heat energy;
transferring the heat energy to a second flow of pressurized air; and
directing the heated, second flow of pressurized air to the tire.

2. The method of claim 1, wherein the tire comprises a rubber material that has an ionic network and can eliminate a tear or a puncture in the tire over a predetermined period of time.

3. The method of claim 1, wherein a tear or a puncture is eliminated from the tire.

4. The method of claim 1, further comprising sending a first signal to the heating element to determine an operating condition of the heating element.

5. The method of claim 1, further comprising providing a tire inflation system, the tire being in selective fluid communication with the tire inflation system.

6. The method of claim 1, wherein the heat energy is transferred to the pressurized air as the pressurized air is directed through a pneumatic control unit.

7. The method of claim 1, further comprising disabling the heating element if the tire pressure is equal to or greater than the target tire pressure.

8. The method of claim 1, further comprising providing a temperature sensor, the temperature sensor measuring a temperature of the heated, second flow of pressurized air directed to the tire.

9. The method of claim 1, further comprising providing a temperature sensor, the temperature sensor measuring a temperature of the heated, second flow of pressurized air directed to the tire.

10. The method of claim 1, further comprising measuring the tire pressure to determine if the tire pressure is below the target tire pressure and, after it is determined that the tire pressure is below the target tire pressure, measuring the tire pressure as the first flow of pressurized air is directed to the tire to determine if the tire is torn or punctured.

11. The method of claim 1, wherein the heating element produces heat energy for a predetermined period of time.

12. The method of claim 1, further comprising directing the heated, second flow of pressurized air to the tire for a predetermined period of time.

13. The method of claim 2, wherein the ionic network comprises ionic groups that include reversible ionic associates.

14. The method of claim 5, wherein the tire inflation system comprises a microcontroller, the microcontroller receiving a signal from the heating element which indicates that the heating element is operating normally and then providing the signal to the heating element to produce heat energy.

15. The method of claim 9, wherein the temperature sensor is in fluid communication with a fluid control circuit and provided near an interface between the tire and the fluid control circuit.

16. The method of claim 14, wherein the microcontroller receives another signal which is indicative of at least one of a power level of a power supply and a pressure in an air supply reservoir.

17. The method of claim 14, wherein the microcontroller provides a signal to a valve assembly which opens the valve assembly and allows the heated, second flow of pressurized air to be directed to the tire.

18. A method of repairing a tire, comprising:
providing a tire, the tire having a tire pressure;
determining if the tire pressure is below a target tire pressure and if the tire pressure is below the target tire pressure directing a first flow of pressurized air to the tire;
determining if the tire is torn or punctured and, if it is determined that the tire is torn or punctured, sending a first signal to a heating element to determine an operating condition of the heating element and sending a second signal to the heating element to produce heat energy;
transferring the heat energy to a second flow of pressurized air; and
directing the heated, second flow of pressurized air to the tire.

19. The method of claim 18, further comprising providing a tire inflation system, the tire inflation system comprising a microcontroller that receives a signal from the heating element which indicates that the heating element is operating normally and then the microcontroller sends the second signal to the heating element to produce heat energy.

20. The method of claim 18, further comprising providing a tire inflation system, the tire inflation system comprising a microcontroller, wherein the microcontroller receives a signal from the heating element or does not receive a signal from the heating element which indicates that the heating element is not operating normally and then the microcontroller records a trouble code.

21. The method of claim 20, wherein, after recording the trouble code, the microcontroller sends a signal to an operator control device indicating a status of the tire inflation system.

22. A master tire pressure maintenance program comprising a method of repairing a tire according to claim 1.
